(19) United States
(12) Patent Application Publication
(10) Pub. No.: US 2002/0034061 A1
(43) Pub. Date: Mar. 21, 2002

(54) Activated carbon for electrode of electric double-layer capacitor

(76) Inventors: Minoru Noguchi, Wako-shi (JP); Shigeki Oyama, Wako-shi (JP); Shushi Nishimura, Bizen-shi (JP)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/861,892

(22) Filed: May 22, 2001

(30) Foreign Application Priority Data
May 23, 2000 (JP) 2000-151454

(51) Int. Cl. H01G 9/00

(52) U.S. Cl. 361/502

(57) ABSTRACT

An activated carbon for an electrode of an electric double-layer capacitor includes an activated carbon fiber produced by using a graphitizing carbon, and an activated carbon powder obtained by pulverizing the activated carbon fiber, thereby increasing the density of the electrode.

### BACKGROUND OF THE INVENTION

1. Field of the Invention

The present invention relates to an activated carbon for an electrode of an electric double-layer capacitor.

2. Description of the Related Art

For such an activated carbon for an electrode, an activated carbon fiber produced by using a mesophase pitch which is a graphitizing carbon as a starting material is conventionally used to aim at an increase in electrostatic capacity of the activated carbon.

The activated carbon fiber is produced by a procedure which comprises producing a fibrous material by spinning the mesophase pitch, subjecting the fibrous material to an infusibilizing treatment and then to a carbonizing treatment, followed by an activating treatment and then a pulverizing treatment, or by a pulverizing treatment and then an activating treatment.

However, even if the length of the conventional activated carbon fiber is shortened by the pulverization, the conventional activated carbon fiber is in the form of a fiber having an aspect ratio. Therefore, when a polarized electrode is formed by using such activated carbon fibers, the following problem is encountered: The fibers are dispersed at random, so that gaps are liable to be created between the fibers. As a result, the electrode density (g/cc) is lower and in turn, the electrostatic capacity density (F/cc) of the electric double-layer capacitor cannot be increased.

### SUMMARY OF THE INVENTION

Accordingly, it is an object of the present invention to provide an activated carbon for an electrode, wherein the electric density can be increased by employing a particular means.

To achieve the above object, according to a first feature of the present invention, there is provided an activated carbon for an electrode of an electric double-layer capacitor, comprising an activated carbon fiber produced by using a graphitizing carbon, and an activated carbon powder obtained by pulverizing the activated carbon fiber.

If the activated carbon is formed as described above, particles of the activated carbon powder can be entered into gaps between the activated carbon fibers, thereby increasing the electrode density. In this case, the activated carbon powder is made from the same material as the activated carbon fiber and hence, the excellent electrostatic capacity characteristic of the activated carbon fiber is not deteriorated by the inclusion of the activated carbon powder.

On the other hand, the polarized electrode of the electric double-layer capacitor is expanded during charging. If a pressing means for increasing the density of the electrode is utilized, there is a possibility that the expansion amount of polarized electrode is increased during the charging, resulting in a disadvantage such as the deformation of a case. However, in a state in which the particles of the activated carbon powder have been entered into the gaps between the activated carbon fibers, as described above, the densification to increase the expansion amount of polarized electrode during charging is not provided and hence, the expansion amount of polarized electrode is little different from that when no activated carbon powder is incorporated.

According to a second feature of the present invention, there is provided an activated carbon for an electrode of an electric double-layer capacitor, wherein the average radius r of particles of said activated carbon powder is represented by r≦(√2−1)R wherein R represents a radius of said activated carbon fiber, and the amount A of said activated carbon powder incorporated into a blend of said activated carbon fiber and said activated carbon powder is in a range of 20% by weight≦A≦80% by weight.

With the above arrangement, the effect provided by the first feature of the present invention are further enhanced.

The above and other objects, features and advantages of the invention will become apparent from the following description of the preferred embodiment taken in conjunction with the accompanying drawings.

### BRIEF DESCRIPTION OF THE DRAWINGS

FIG. 1 is a broken-away front view of an essential portion of a button-shaped electric double-layer capacitor;

FIG. 2 is a graph showing the relationship between pulverizing time and the average radius of an activated carbon powder;

FIG. 3 is a graph showing the relationship between the average radius r of the activated carbon powder and the electrostatic capacity density;

FIG. 4 is a diagram showing one example of the relationship between an activated carbon fiber and the activated carbon powder;

FIG. 5 is a diagram showing another example of the relationship between the activated carbon fiber and the activated carbon powder;

FIG. 6 is a graph showing the relationship between the amount A of the activated carbon powder incorporated and the electrode density; and

FIG. 7 is a graph showing the relationship between the amount A of the activated carbon powder incorporated and the electrostatic capacity density.

### DESCRIPTION OF THE PREFERRED EMBODIMENT

The present invention will now be described by way of an embodiment with reference to the accompanying drawings.

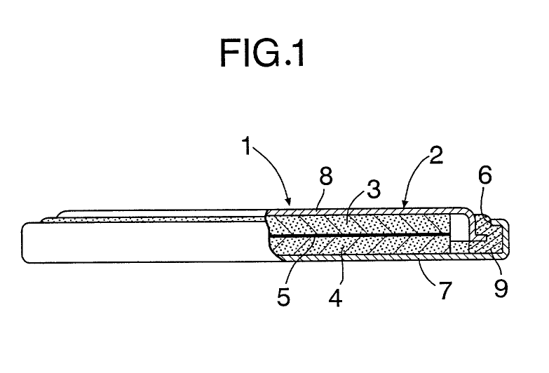

Referring to FIG. 1, a button-shaped electric double-layer capacitor 1 includes a case 2, a pair of polarized electrodes 3 and 4 accommodated in the case 2, a spacer 5 sandwiched between the polarized electrodes 3 and 4, and an electrolyte filled in the case 2. The case 2 comprises a body 7 made of aluminum and having an opening 6, and a lid plate 8 made of aluminum for closing the opening 6. An outer periphery of the lid plate 8 and an inner periphery of the body 7 are sealed by a seal material 9. Each of the polarized electrodes 3 and 4 is a mixture comprising an activated carbon, a conductive filler and a binder.

The activated carbon for the electrodes comprises an activated carbon fiber produced by using a graphitizing activated carbon, and an activated carbon powder obtained by pulverizing the activated carbon.

To produce the activated carbon fiber, the following process was carried out: (a) A fiber having a radius R equal to 12 μm was produced by spinning a mesophase pitch which is a graphitizing carbon. (b) The fiber was subjected to a pulverizing treatment at room temperature to produce a pulverized fiber having an average length L equal to 25 mn, and the pulverized fiber was subjected to an infusibilizing treatment for two hours at 350° C. in an atmospheric air current and then to a carbonizing treatment for one hour at 700° C. in a nitrogen gas current, thereby producing a carbonized fiber. (c) The carbonized fiber and KOH in an amount twice as large as the amount of carbon contained in the carbonized fiber were mixed together, and the resulting mixture was subjected to a potassium activating treatment as an alkali activating treatment for 5 hours at 800° C. in a nitrogen gas current. Thereafter, the mixture was subjected to post-treatments: neutralization using hydrochloric acid, washing and drying, thereby obtaining an activated carbon fiber having an average length L of 25 μm.

Then, the activated carbon fiber was subjected to a pulverizing treatment in a ball mill. In this case, the treatment time was varied to produce activated carbon powders having various average radii r.

Table 1 shows the relationship between pulverizing time and the average radius r of Examples (1) to (7) of the activated carbon powders.

TABLE 1

| Example of activated | | |
|---|---|---|
| carbon powder | Pulverizing time (hr) | Average radius r (μm) |
| (1) | 5 | 6.2 |
| (2) | 8 | 4.0 |
| (3) | 12 | 3.1 |
| (4) | 24 | 2.3 |
| (5) | 36 | 2.2 |
| (6) | 48 | 1.8 |
| (7) | 72 | 2.1 |

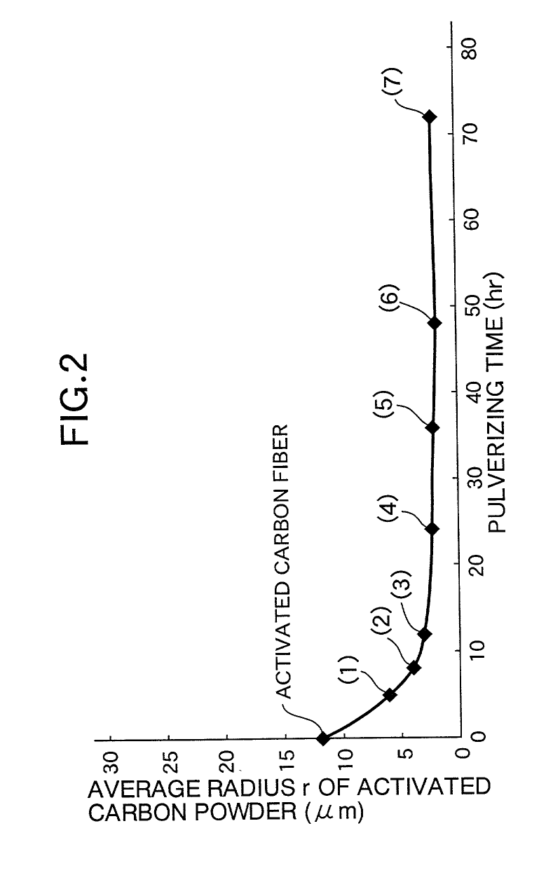

FIG. 2 is a graph which is based on Table 1 and showing the relationship between the pulverizing time and the average radius r for Examples (1) to (7) of the activated carbon powders. In FIG. 2, (1) to (7) correspond to Examples (1) to (7), respectively.

The average radius r of the activated carbon powder is decreasing with time at the early stages, but becomes substantially constant around 2 μm after 24 hours of pulverizing.

A button-shaped electric double-layer capacitor 1 shown in FIG. 1 was fabricated by using the activated carbon fiber and Examples (1) to (7) of the activated carbon powders in a process which will be described below.

(a) A blend comprising 40% by weight of the activated carbon fiber and 60% by weight of Example (1) of the activated carbon powder was prepared. (b) 80% By weight of the blend, 10% by weight of a graphite powder (a conductive filler) and 10% by weight of PTFE (a binder) were kneaded together. (c) The resulting kneaded material was subjected to rolling to fabricate an electrode sheet having a thickness of 185 μm. (d) Two polarized electrodes 3 and 4 having a diameter of 20 mm were cut out from the electrode sheet, and a button-shaped electric double-layer capacitor 1 was fabricated by using the two polarized electrodes 3 and 4, a spacer 5 made of a glass fiber and having a diameter of 22 mm and a thickness of 160 μm, an electrolyte and other materials. The electrolyte used was a 1.4 M solution of triethylmethyl-ammonium-tetrafluoroborate [(C₂H₅)₃CH₃NBF₄] in propylene carbonate.

The button-shaped electric double-layer capacitor fabricated by using Example (1) of the activated carbon fiber is hereinafter called Sample (1). Samples (2) to (7) of the button-shaped electric double-layer capacitor were made in the same manner using Examples (2) to (7) of the activated carbon fibers. Further, Sample (0) of the electric double-layer capacitor was made in the same manner using the activated carbon fiber without activated carbon powder. In these Samples, the amount of activated carbon fiber blended in the kneaded material was 80% by weight.

For each of Samples (0) to (7), an electrostatic capacity density per unit weight (F/g) was measured at a charging voltage of 2.5 V and a charging current of 5 mA. Based on the obtained measurement and the electrode density, an electrostatic capacity density per unit volume (F/cc) was obtained. Table 2 shows the average radius r of the activated carbon powder, the electrode density and the electrostatic capacity density (F/cc) for Samples (1) to (7). Also, data for Sample (0) are shown in Table 2. In this case, the radius R of the activated carbon fiber corresponds to the average radius.

TABLE 2

| | Average radius | | Electrostatic |
|---|---|---|---|
| | r (μm) of activated | Electrode density | capacity density |
| Sample | carbon powder | (g/cc) | (F/cc) |
| (1) | 6.2 | 0.84 | 31.7 |
| (2) | 4.0 | 0.88 | 33.0 |
| (3) | 3.1 | 0.89 | 33.6 |
| (4) | 2.3 | 0.90 | 33.8 |
| (5) | 2.2 | 0.92 | 34.6 |
| (6) | 1.8 | 0.98 | 35.0 |
| (7) | 2.1 | 0.98 | 35.1 |
| (0) | 12.0 | 0.80 | 29.5 |
| | (R) | | |

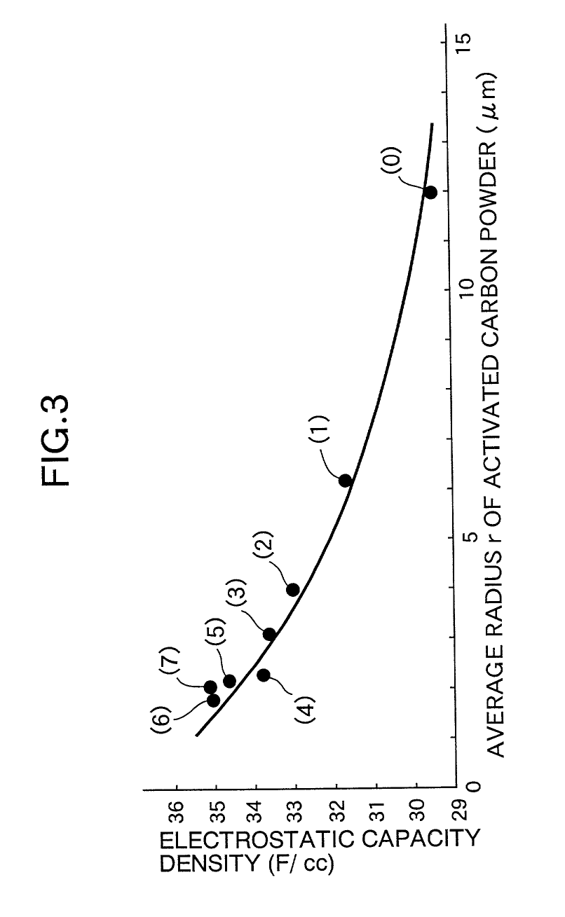

FIG. 3 is a graph which is based on Table 2 and showing the relationship between the average radius r of the activated carbon powder and the electrostatic capacity density (F/cc) for Samples (0) to (7). In FIG. 3, (0) to (7) correspond to Samples (0) to (7), respectively.

As apparent from FIG. 3, it can be seen that when the radius R of the activated carbon fiber is equal to 12 μm, if the average radius r of the activated carbon powder is set at a value ≦5 μm, the electrostatic capacity density (F/cc) is increased steeply. If the average radius r of the activated carbon powder is set in a range of 1.8 to 2.1 μm, the electrostatic capacity density (F/cc) assumes a maximum value.

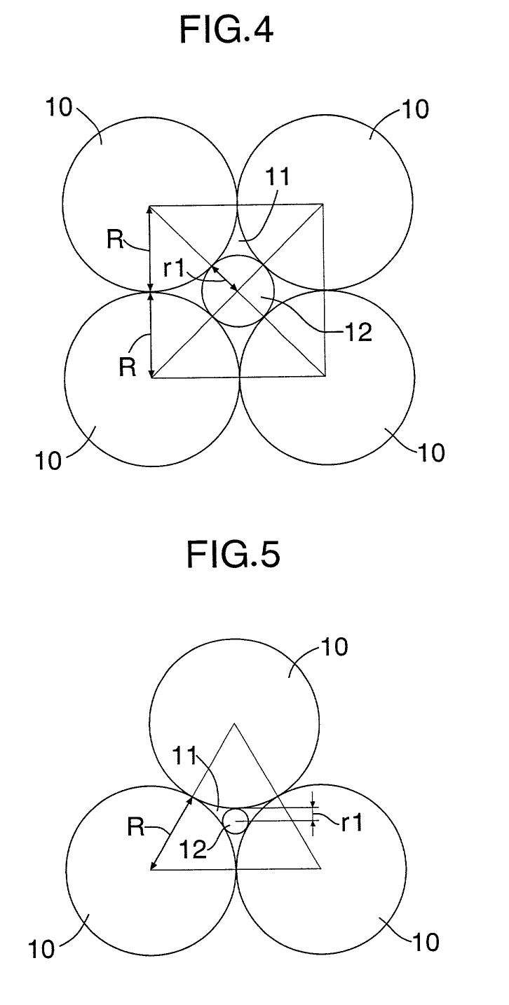

The activated carbon powder having an average radius r of 5 μm assumes, for example, a packed structure as shown in FIG. 4. More specifically, if four activated carbon fibers 10 are disposed with the adjacent fibers in contact with one another, and a substantially quadrilateral gap surrounded by the activated carbon fibers 10 is defined, the maximum radius r1 of particles of the activated carbon powder 12 entering the gap 11 is represented by an equation r1=(√2−1)R, wherein the radius of the activated carbon fibers 10 is R. Here, if R is equal to 12 μm, r1≈5 μm and hence, r1≈r is established.

On the other hand, the activated carbon powder 12 having an average radius r of 1.8 μm assumes, for example, a packed structure as shown in FIG. 5. More specifically, if three activated carbon fibers 10 are disposed with the adjacent fibers in contact with one another, and a substantially triangular gap 11 surrounded by the activated carbon fibers 10 is defined, the maximum radius r1 of particles of the activated carbon powder 12 entering the gap 11 is represented by an equation r1={(2√3/3)−1}R, wherein the radius of the activated carbon fibers 10 is R. Here, if R is equal to 12 μm, r1≈1.86 μm and hence, r1≈r is established.

Therefore, it can be said from FIGS. 3 and 4 that when the radius of the activated carbon fibers 10 is defined as R, it is desirable to set the average radius r of the particles of the activated carbon powder 12 at r≦(√2−1)R.

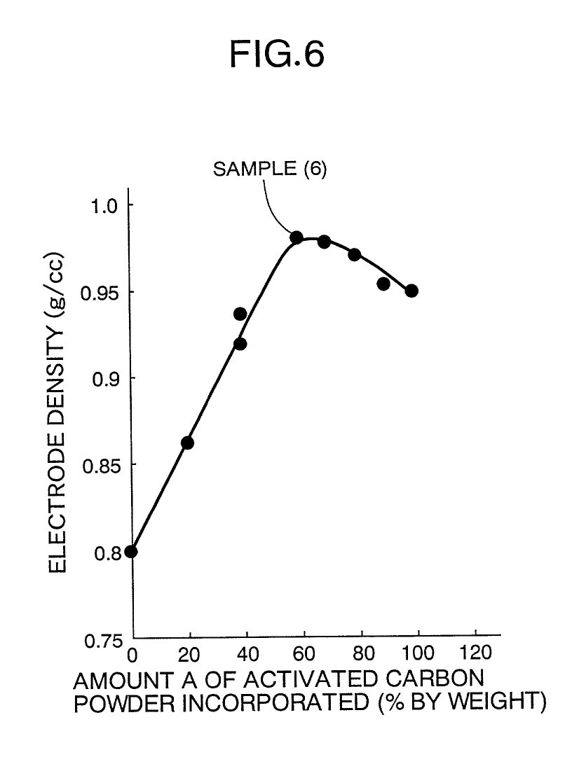

FIG. 6 shows a variation in electrode density in Sample (6) of the button-shaped electric double-layer capacitor, when the amount A of activated carbon powder (having an average radius r=1.8 μm) incorporated has been varied. If the amount A of activated carbon powder incorporated is smaller than 20% by weight, a smaller effect of increasing the electrode density is provided. On the other hand, if A>80% by weight, the amount of the activated carbon powder is too large, resulting in a degraded dispersibility of the binder. For this reason, the handleability of the kneaded material is degraded to hinder, for example, rolling operation, and the electrode density tends to decrease.

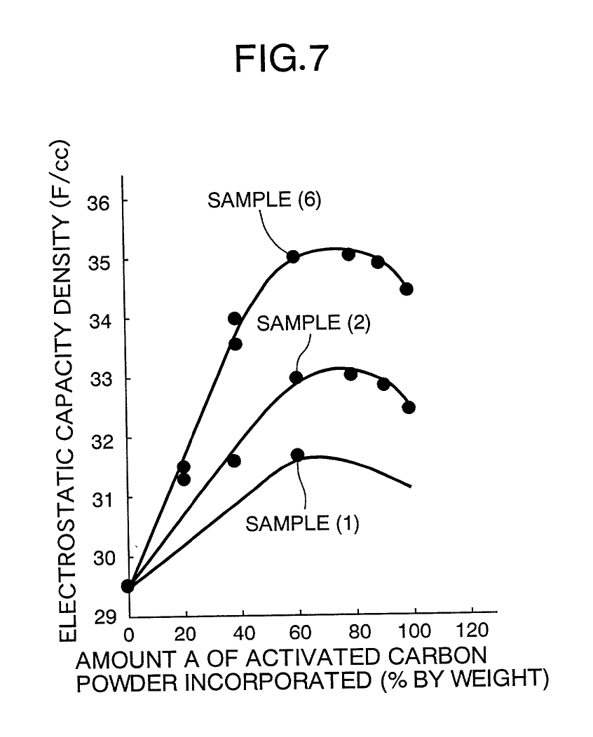

FIG. 7 shows a variation in Sample (6) of electrostatic capacity density (F/cc) in the button-shaped electric double-layer capacitor, when the amount A of activated carbon powder (having an average radius r=1.8 μm) incorporated has been likewise varied. Data for Samples (1) and (2) are also given in FIG. 7. In each case, if the amount A of activated carbon powder incorporated is smaller than 20% by weight, a smaller effect of increasing the electrostatic capacity density is provided. On the other hand, if A>80% by weight, the handleability of the kneaded material is likewise degraded, and the electrostatic capacity density tends to decrease with a reduction in electrode density.

It can be said from FIGS. 6 and 7 that the amount A of activated carbon powder incorporated in the blend of the activated carbon fiber and the activated carbon powder is proper to be: 20% by weight≦A≦80% by weight.

Although the embodiment of the present invention has been described in detail, it will be understood that the present invention is not limited to the above-described embodiment, and various modifications in design may be made without departing from the spirit and scope of the invention.

What is claimed is

1. An activated carbon for an electrode of an electric double-layer capacitor, comprising an activated carbon fiber produced by using a graphitizing carbon, and an activated carbon powder obtained by pulverizing said activated carbon fiber.

2. An activated carbon for an electrode of an electric double-layer capacitor according to claim 1, wherein the average radius r of particles of said activated carbon powder is represented by r≦(√2−1)R wherein R represents a radius of said activated carbon fiber, and the amount A of said activated carbon powder incorporated into a blend of said activated carbon fiber and said activated carbon powder is in a range of 20% by weight≦A≦80% by weight.
